(19) United States
(12) Patent Application Publication
(10) Pub. No.: US 2019/0335080 A1
(43) Pub. Date: Oct. 31, 2019

(54) IMAGE CAPTURING APPARATUS

(71) Applicant: CANON KABUSHIKI KAISHA, Tokyo (JP)

(72) Inventor: Taro Takita, Kawasaki-shi (JP)

(21) Appl. No.: 16/388,683

(22) Filed: Apr. 18, 2019

(30) Foreign Application Priority Data
Apr. 27, 2018 (JP) 2018-086496

(51) Int. Cl. H04N 5/235; H04N 5/262

(52) U.S. Cl. CPC H04N 5/2353; H04N 5/2625; H04N 5/2355

(57) ABSTRACT

An image capturing apparatus that repeatedly captures an image of an object at a first timing includes an image sensor configured to acquire image data of the object, a control unit configured to control driving of the image sensor, and an acquisition unit configured to acquire a second timing generated by image pattern detection for repeatedly processing the object. The control unit controls driving of the image sensor based on an interval between the first timings and an interval between the second timings.

### BACKGROUND OF THE INVENTION

### Field of the Invention

The present disclosure generally relates to an image capturing apparatus that interfaces with an external environment, and a method for controlling the image capturing apparatus.

### Description of the Related Art

As an example of an image capturing system for capturing an image of an object, a control method for acquiring a still image based on a timing signal generated by detecting an image pattern in image data (hereinafter referred to as an image pattern detection signal) is known. This control method is used for applications covering factory automation (hereinafter also referred to as FA) and academic pursuits. In the control method, an intended image capturing timing may be delayed depending on an output timing of the pattern detection signal or on a method of driving an image sensor. To cope with various subject conditions, a plurality of images with different types of exposures is combined or a long exposure is required in some cases, which raises a concern of a further increase in delay.

### SUMMARY OF THE INVENTION

According to an aspect of the present disclosure, an image capturing apparatus that repeatedly captures an image of an object at a first timing includes an image sensor configured to acquire image data of the object, and a controller having a processor which executes instructions stored in a memory, the controller being configured to function as a control unit configured to control driving of the image sensor, and an acquisition unit configured to acquire a second timing generated by detecting an image pattern of the object in the image data. The control unit controls driving of the image sensor based on an interval between the first timings and an interval between the second timings.

Further features of the present disclosure will become apparent from the following description of exemplary embodiments with reference to the attached drawings.

### BRIEF DESCRIPTION OF THE DRAWINGS

FIG. 1 is a block diagram illustrating an overall configuration of an image capturing system according to a first exemplary embodiment.

FIG. 2 is a configuration diagram illustrating the image capturing system according to the first exemplary embodiment.

FIGS. 3A and 3B are timing diagrams each illustrating a high dynamic range (HDR) drive mode.

FIG. 4 is a flowchart illustrating an operation according to the first exemplary embodiment.

FIGS. 5A and 5B illustrate a cutter operation and trigger points on an inspection table according to each exemplary embodiment.

FIGS. 6A, 6B, 6C, and 6D are timing diagrams each illustrating an operation according to the first exemplary embodiment.

FIG. 7 is a block diagram illustrating an overall configuration of an image capturing system according to a second exemplary embodiment.

FIGS. 8A and 8B are timing diagrams each illustrating a slow shutter drive mode.

FIG. 9 illustrates an optimum pattern detection position and a displacement amount according to the second exemplary embodiment.

FIGS. 10A, 10B, and 10C are flowcharts each illustrating an operation according to the second exemplary embodiment.

### DESCRIPTION OF THE EMBODIMENTS

Exemplary embodiments of the present disclosure will be described below with reference to the drawings. Throughout the drawings, components having the same function are denoted by the same reference numerals, and repeated descriptions thereof are omitted. The components are not limited to contents described in the exemplary embodiments and can be modified as appropriate.

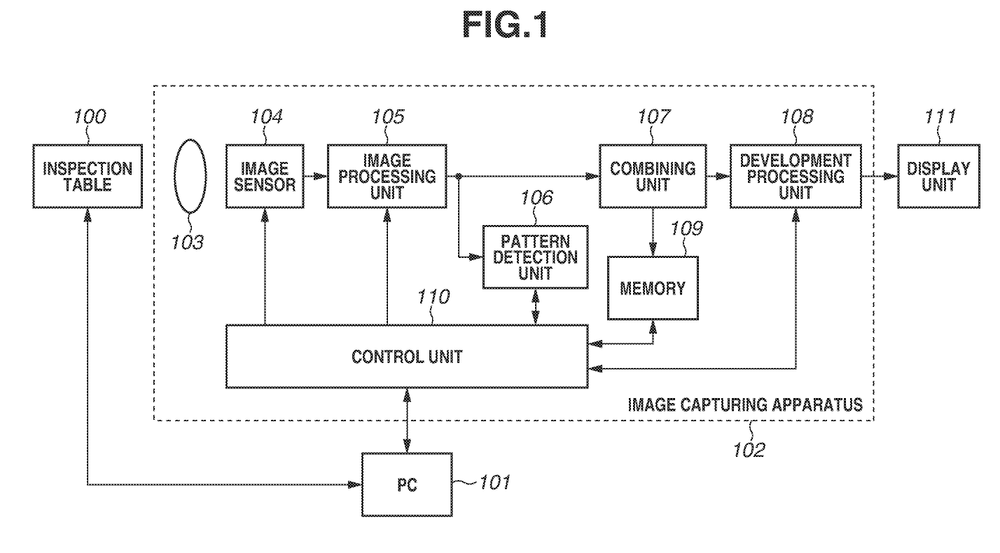

An overall configuration of an image capturing system including an image capturing apparatus 102 according to a first exemplary embodiment will be described with reference to a detailed block diagram illustrated in FIG. 1. An inspection table 100 is used to mount a target object. The inspection table 100 includes a stage for changing the position of the target object, and an electronic apparatus such as a cutter for cutting the object. The inspection table 100 may also include a heater for heating the object, and a draft for scavenging the atmosphere containing noxious substance.

Each electronic apparatus mounted on the inspection table 100 can be operated from an external apparatus that includes a control unit for controlling a communication port and each apparatus used for operation of the system.

An external apparatus 101 is, for example, a personal computer (hereinafter also referred to as a PC). The PC 101 controls the entire image capturing system and supplies the inspection table 100 and each block of the image capturing apparatus 102 to be described below with control signals, setting information, and the like. The present exemplary embodiment assumes a case where each control object is connected via a wire such as a local area network (LAN) cable or a universal serial bus (USB) cable. However, each control object may be connected via a wireless connection such as Wi-Fi®, or may be connected to each apparatus through another apparatus via a network. The PC 101 is not limited to a general configuration including a mouse and a keyboard as an input unit, but instead may have a configuration including a joystick, a dedicated switch board, or a track ball, or a configuration including a touch panel of a tablet PC or the like.

The image capturing apparatus 102 captures an image of an object mounted on the inspection table 100, and outputs the image capturing result as image data. The image data is output to a display unit 111 or the PC 101, or may be output and stored in a memory card or the like provided in the image capturing apparatus 102, or may be output to a storage or a cloud service.

An image capturing lens 103 corresponds to an image capturing optical system that focuses light from a subject and forms a subject image. The image capturing lens 103 is a lens group including a zoom lens and a focus lens.

The image capturing lens 103 may be configured to be detachably and replaceably mounted on a main body of the image capturing apparatus 102. The image capturing lens 103 includes a shutter mechanism, an aperture mechanism, and an anti-vibration mechanism, which are not illustrated. Examples of the aperture mechanism include an aperture mechanism of a form in which an aperture diameter is controlled by a plurality of aperture blades, an aperture mechanism of a form in which a plate having a plurality of holes with different diameters formed therein is caused to move in and out, and an aperture mechanism of a form in which an optical filter, such as a neutral density (ND) filter, is inserted or removed. The aperture mechanism may have any form, as long as an exposure amount can be adjusted.

An image sensor 104 includes a charge-coupled device (CCD) or a complementary metal-oxide semiconductor (CMOS), which converts a subject image (optical image) formed by the image capturing lens 103 into an electrical signal. The image sensor 104 according to the present exemplary embodiment includes at least four thousand pixels in a horizontal direction and two thousand or more effective pixels in a vertical direction, and can output, for example, 4K-format image data at a frame rate of 30 fps. The image sensor 104 also includes a register for setting control parameters. A drive mode, including an exposure time, exposure parameters such as gain, a read-out timing, and operations such as thinning and binning, can be controlled by changing the setting of the register. The image sensor 104 according to the present exemplary embodiment includes an analog-to-digital (AD) conversion circuit, and outputs digital image data, corresponding to one frame, in synchronization with a timing signal (hereinafter also referred to as a VD) supplied from an external apparatus. The image sensor 104 can also output a moving image at a predetermined frame rate in a normal drive mode. In the present exemplary embodiment, a series of timing signals are provided by a vertical synchronization signal and each timing signal corresponds to a first timing which is a timing at which an image of an object is captured. An interval between the timing signals (VDs) corresponds to an interval between the first timings.

The drive mode of the image sensor 104 includes a drive mode for periodically switching the setting of the exposure time based on a plurality of exposure times set in the register (this drive mode is hereinafter also referred to as a high dynamic range (HDR) mode). By using this drive mode, a low-exposure image with an exposure time less than a proper exposure time and a high-exposure image with a longer exposure time can be alternately acquired for each VD. By combining these images, an image with an increased dynamic range (this image is hereinafter also referred to as an HDR image) can be obtained. A setting for gain can also be changed, as needed, when the exposure time is changed. As a setting for exposure, a proper exposure image may be combined with a high-exposure image or a low-exposure image. In the present exemplary embodiment, a block that includes the image sensor 104 and acquires an image, corresponds to an image capturing unit. The image sensor 104 is not limited to a single-chip type image sensor including color filters of a Bayer array. The image sensor 104 may be a three-chip type including image sensors corresponding to red (R), green (G), and blue (B) color filters, respectively, included in the Bayer array. The image sensor 104 may include a clear (white) filter instead of the color filters. An image sensor capable of receiving light in an infrared or ultraviolet region can also be used as the image sensor 104.

An image processing unit 105 performs processing such as gain or offset correction, white balance correction, contour enhancement, and noise reduction, as needed, on the read image data. The image processing unit 105 also performs predetermined pixel interpolation processing, resize processing, such as reduction, and color conversion processing on the image data output from the image sensor 104. The image processing unit 105 also performs predetermined arithmetic processing using various signals. Based on the obtained arithmetic processing results, a control unit 110 or the like to be described below performs exposure control and focus detection control. As a result, automatic exposure (AE) processing using a through-the-lens (TTL) method, electronic flash pre-emission (EF) processing, or the like is carried out. The image processing unit 105 also performs autofocus (AF) processing. In the HDR mode, control processing may be performed in such a manner that image processing performed on a low-exposure image with a short exposure time and image processing performed on a high-exposure image with a long exposure time differ. Some of the functions of the image processing unit 105 may be provided in the image sensor 104 so as to distribute a processing load.

A pattern detection unit 106 detects a specific image pattern from predetermined image data output from the image processing unit 105, and generates an appropriate timing signal. In particular, in the present exemplary embodiment, the pattern detection unit 106 generates a timing for acquiring an HDR combined image corresponding to one frame from a memory 109 to be described below. In the present exemplary embodiment, an image pattern indicating a positional relationship between the above-described cutter and an object to be inspected is detected to thereby detect a cutting timing for acquiring a still image of the object to be inspected. However, the present exemplary embodiment can also be applied to factory automation (FA) and the like. For example, the present exemplary embodiment can also be applied to a case where a predetermined position or angle of an object to be inspected which is conveyed on a belt conveyor or the like is detected using a pattern. The pattern detection unit 106 is disposed at an output stage of the image processing unit 105 so as to reduce effects of noise or fixed pattern noise, or the pattern detection unit 106 may instead be disposed at an output stage of the image sensor 104, as long as pattern detection can be performed. The pattern detection can also be performed by acquiring an image stored in the memory 109 to be described below.

Examples of the pattern detection method include a method using template matching. Specifically, an image is compared with a template image to determine whether a specific object is captured in the image. Another method may include determining whether an image similar to an image acquired at a timing based on a trigger signal supplied from an external apparatus, is acquired. Alternatively, a pattern may be detected by repeated learning using artificial intelligence (AI). In order to improve the accuracy of pattern detection, marking may be used on an object to be detected and pattern detection may be implemented by detecting the marking.

A combining unit 107 generates an HDR image by combining two pieces of image data from two images, i.e., a low-exposure image and a high-exposure image, which are processed by the image processing unit 105. The HDR image is generated in such a manner that each piece of image data is divided into a plurality of blocks to be processed and combining processing is performed on each corresponding block. To simplify the explanation, the present exemplary embodiment illustrates an example of acquiring and combining two pieces of image data, but the present exemplary embodiment is not limited to this example. For example, three or more pieces of image data may be acquired and combined. There is a disadvantage that an increase in the number of pieces of image data to be acquired and combined leads to an increase in time required for acquiring the image data. However, there is an advantage that the dynamic range in the HDR image can be increased depending on the number of images to be combined. If image combining processing is not performed in a mode other than the HDR mode, such as a normal moving image mode, the image data processed by the image processing unit 105 may be controlled to be directly input to a development processing unit 108.

The development processing unit 108 performs compression coding on the image data processed by the combining unit 107 to be converted into a brightness signal, a color difference signal, or a predetermined moving image format such as a Moving Picture Experts Group (MPEG) format. The development processing unit 108 also performs compression coding on a still image to be converted into a different format such as a Joint Photographic Experts Group (JPEG) format. The processed image data is output and displayed on the display unit 111. Further, the image data is stored, as needed, in a recording unit (not illustrated). The display unit 111 may be included in the PC 101, or may be separately provided.

The memory 109 temporarily records image data of still images. The memory 109 has a storage capacity that enables recording of image data corresponding to one or more frames, and records the image data processed by the combining unit 107.

In the case of driving the image sensor 104 in the moving image mode to obtain a moving image from a plurality of pieces of image data, image data is acquired at a frame rate in a range from 30 fps to 60 fps. To smoothly reproduce each piece of image data, or to ensure a sufficient storage capacity, the image data is irreversibly subjected to compression coding in the development processing unit 108 and is then stored in a predetermined moving image format. Accordingly, when image data of a still image is obtained by extracting image data corresponding to one frame from a moving image subjected to compression coding processing, in some cases, a sufficient gradation cannot be obtained, or high-frequency components are removed from the image, which causes a lack of fineness, and thus the image is not suitably used. In addition, there is a concern about a deterioration in image quality due to noise caused by compression coding processing. Accordingly, the image data that has not been processed by the development processing unit 108 is held in the memory 109, thereby making it possible to acquire not only image data of a moving image, but also image data of a still image with a high image quality. A ring buffer is used as the memory 109, and old image data is overwritten with new image data and the overwritten image data is stored, so that a plurality of images can be repeatedly held with a small storage capacity.

In the present exemplary embodiment, the memory 109 is configured to hold the image data processed by the combining unit 107, but instead may be configured to store the image data processed by the image processing unit 105. In addition, the memory 109 stores various image data acquired by the image capturing unit and data to be displayed on the display unit 111. The memory 109 has a storage capacity sufficient for storing audio as well as image data. The memory 109 may also be used as a memory for image display (video memory).

The control unit 110 controls various calculations and the entire image capturing apparatus 102. The control unit 110 includes a central processing unit (CPU) for controlling components for controlling the entire image capturing apparatus 102 in an integrated manner, and performs setting of various setting parameters and the like for each component. Programs recorded on the above-described memory 109 are executed to thereby implement each processing according to the present exemplary embodiment as described below. The control unit 110 also includes a system memory. For example, a static random access memory (SRAM) is used as the system memory. Constants and variables for operation of the control unit 110, and programs read from a nonvolatile memory or the like are loaded into the system memory.

The nonvolatile memory is an electrically erasable/recordable memory. For example, a flash memory is used as the nonvolatile memory. The nonvolatile memory stores constants for operation of the control unit 110, programs, and the like. Programs described herein refer to programs for executing various flowcharts to be described below according to the present exemplary embodiment. The control unit 110 also includes a system timer to measure the time used for various control processing and measure the time of an incorporated clock. The control unit 110 may include hardware circuits, including a reconfigurable circuit, in addition to the CPU that executes programs.

The control unit 110 also includes a communication unit (not illustrated), and is connected to the PC 101, which is an external apparatus, based on a wired communication port or a wireless communication unit. The image capturing apparatus 102 may be provided with an operation unit for switching modes or the like.

The PC 101 according to the present exemplary embodiment controls the inspection table 100 and each block of the image capturing apparatus 102. In particular, the inspection table 100 includes the cutter for cutting an object to be inspected, which is an object used for an inspection, and controls a repeated operation of the cutter and performs speed detection. Information about the detected speed data is transmitted to the control unit 110 in the image capturing apparatus 102, and image data of a still image is loaded into the PC 101.

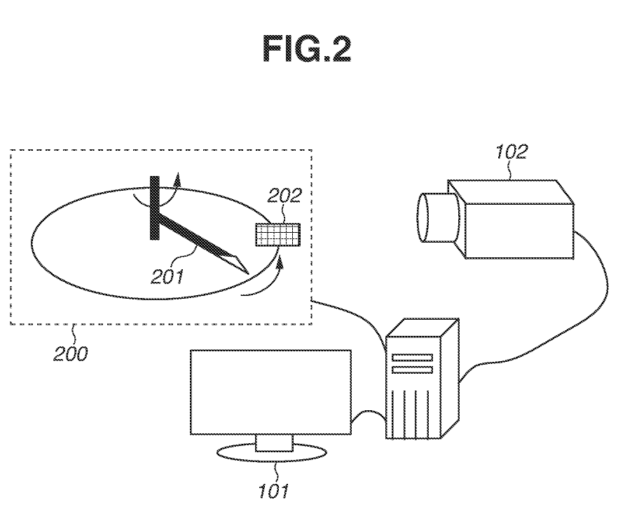

FIG. 2 is a configuration diagram illustrating the image capturing system according to the present exemplary embodiment. The inspection table 100 is provided with an inspection stage 200, a cutter 201, and an object-to-be-inspected 202. The object-to-be-inspected 202 is a test sample, such as a living organism or plant. More specifically, the object-to-be-inspected 202 placed on the inspection stage 200 can be cut by the cutter 201. The cutter 201 is rotatable with respect to a predetermined axis, and the inspection stage 200 or the cutter 201 is configured in such a manner that the position where the object-to-be-inspected 202 is cut can be changed depending on the rotation of the cutter 201. In other words, the object-to-be-inspected 202 can be repeatedly cut by rotating the cutter 201 at a predetermined cycle, and a section of the object-to-be-inspected 202 can be continuously observed and analyzed. The cutter 201 according to the present exemplary embodiment is an example of processing the object-to-be-inspected 202. The present exemplary embodiment is not limited to the cutting operation, but also is suitable for a repeated operation to be performed on the object-to-be-inspected 202. For example, the present exemplary embodiment is also applicable to a case where a predetermined apparatus is used for compression, heating, cooling, or addition of a reagent.

The image capturing apparatus 102 is fixed in such a manner that a focus is made on the section of the object-to-be-inspected 202 placed on the inspection stage 200. The PC 101 is connected to each of the inspection table 100 and the image capturing apparatus 102 with a wired cable to control a position of the inspection table 100 in the vertical direction at which the object-to-be-inspected 202 is cut by the cutter 201 without a miss. After the object-to-be-inspected 202 is cut, the position of the cutter 201 is controlled to move vertically downward so as to reliably cut the object-to-be-inspected 202 in a subsequent rotation. A timing for the image capturing apparatus 102 to capture an image of a state where the object-to-be-inspected 202 is cut is controlled.

In the present exemplary embodiment, the image capturing apparatus 102 is driven in the HDR mode, and the combined HDR image is output as image data of a moving image. Then, image data of a still image is output in accordance with a pattern detection signal generated at a timing when the object-to-be-inspected 202 is cut. The pattern detection unit 106 detects an image pattern indicating a positional relationship between the cutter 201 and the object-to-be-inspected 202, and outputs a pattern detection signal to the control unit.

The pattern detection unit 106 preliminarily stores a pattern in a frame which is one frame before the timing of capturing an image. The PC 101 supplies a control signal to enable control of an output timing of each piece of image data such that the image data is autonomously output at a predetermined timing.

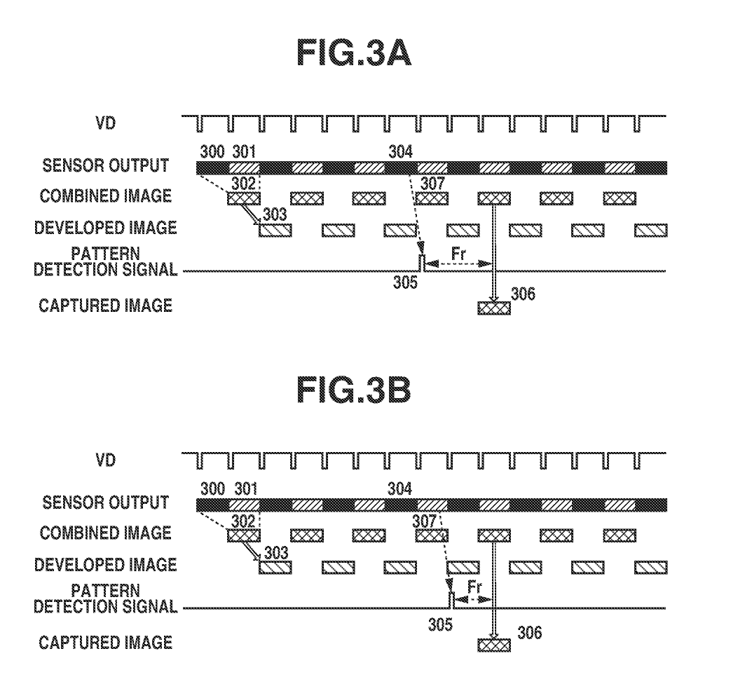

FIGS. 3A and 3B are timing diagrams each illustrating an image capturing operation in the image capturing system according to the present exemplary embodiment. FIG. 3A and 3B differ in the timing at which the pattern detection signal for generating a timing when an HDR combined image corresponding to one frame is acquired by the pattern detection unit 106. In the operation illustrated in FIGS. 3A and 3B, the image sensor 104 is set to be driven in the HDR mode, and repeatedly and alternately outputs a low-exposure image 300 with a short exposure time and a high-exposure image 301 with a long exposure time in synchronization with a VD. Two successive pieces of output image data are combined as a pair by the combining unit 107, thereby generating an HDR image 302.

Combining processing for generating the HDR image is performed immediately after acquiring the low-exposure image 300 and the high-exposure image 301 in this order. Then, the development processing unit 108 outputs image data of a moving image subjected to development processing. As illustrated in FIGS. 3A and 3B, when the read-out timing is fixed with respect to the VD in each piece of image data, the acquisition (exposure) timing of the high-exposure image is separated from that of the low-exposure image. Accordingly, it is not preferable to combine a high-exposure image and a low-exposure image which are acquired in the order of high-exposure image before low-exposure image. The output image data may be stored in the image capturing apparatus 102, or may be loaded into the PC 101 via a wired cable.

Referring to FIGS. 3A and 3B, a pattern detection signal 305 is output when a predetermined pattern is detected on an image by the pattern detection unit 106. This timing is asynchronous with the image acquisition timing and is associated with the positional relationship between the cutter 201 and the object-to-be-inspected 202. When the pattern detection signal 305 is output and received by the control unit 110, image data of a still image is captured. Image data to be actually captured corresponds to an image obtained by combining the low-exposure image and the high-exposure image which are obtained after the pattern detection signal 305 is output. A combined image 307 obtained immediately after the pattern detection signal 305 is output may be captured. However, since the output of the pattern detection signal 305 is asynchronous with the acquisition of the image data, the acquisition of the data is not always ensured. For example, to save the memory capacity of the memory 109 that holds the combined image 307, a part of the memory 109 may be shared for different processing (such as development processing). In this case, at a time point when the pattern detection signal 305 is input, the data of the combined image 307 can be corrupted (overwritten). On the other hand, to prevent sharing of the memory 109, there is a need to increase the memory capacity, which causes an adverse effect such as an increase in cost. When the asynchronously input pattern detection signal 305 is used as a trigger for acquiring data, it is advantageous to use image data to be subsequently acquired in terms of saving the memory capacity.

In FIGS. 3A and 3B, Fr represents a period (the number of frames) for capturing an image from the pattern detection signal. In the example of FIG. 3A, Fr=3 frames. In the example of FIG. 3B, Fr=2 frames. Specifically, when the pattern detection unit 106 detects a pattern from the high-exposure image and the pattern detection signal is generated, a combined image can be acquired with a small time lag.

FIGS. 3A and 3B each illustrate the operation for generating the HDR image using a pair of two successive pieces of image data, alternatively a set of three or more pieces of image data may be used to acquire an intermediate exposure image.

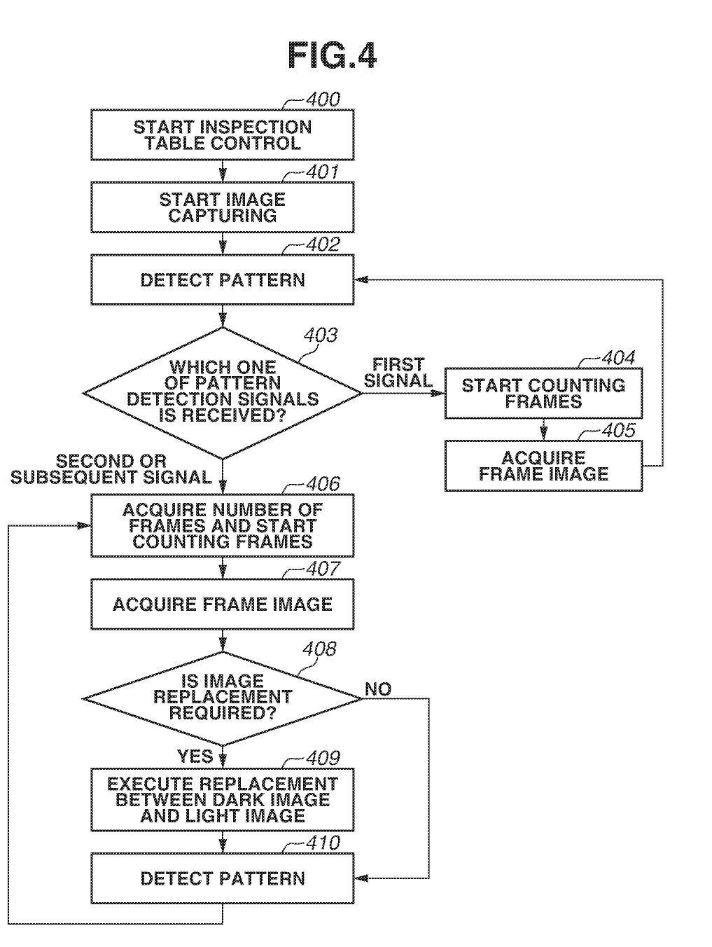

Next, an inspection operation for the object-to-be-inspected 202 according to the present exemplary embodiment will be described with reference to a flowchart illustrated in FIG. 4. The processing in this flowchart is mainly performed by the control unit 110 in the image capturing apparatus 102.

Upon start of the operation of the image capturing apparatus 102, the PC 101 starts control processing on the inspection table 100. Specifically, in association with a start control from the PC 101, the rotation operation of the cutter 201 and the initialization of relative positions of the cutter 201 and the object-to-be-inspected 202 are performed. At the time of starting the rotation operation of the cutter 201, the rotation speed of the cutter 201 is unstable. For this reason, the processing in this flowchart is started after the object-to-be-inspected 202 is controlled to be located at a position where the object-to-be-inspected 202 does not contact the cutter 201 and a sufficient time elapses so that the speed of the cutter 201 is controlled at a constant speed.

In step S401, the control unit 110 starts the image capturing operation based on an operation start instruction from the PC 101. Specifically, setting of parameters for the drive mode and setting of exposure conditions are performed on the image sensor 104, and then supply of the VDs and a clock for operation is started. When each operation is started, image data obtained by the image capturing operation is output at a predetermined frame rate.

In this flowchart, the image sensor 104 is driven in the HDR mode and outputs the HDR image obtained by combining the low-exposure image and the high-exposure image as illustrated in FIGS. 3A and 3B. On the other hand, upon start of this step, the PC 101 communicates with the inspection table 100 and sets the height of the cutter 201 with respect to the object-to-be-inspected 202 to be aligned with the cutting position of the object-to-be-inspected 202. Then, the processing proceeds to step S402.

In step S402, the control unit 110 receives the pattern detection signal from the pattern detection unit 106. The pattern detection signal is associated with the rotation timing of the cutter 201 of the inspection table 100. Then, the processing proceeds to step S403.

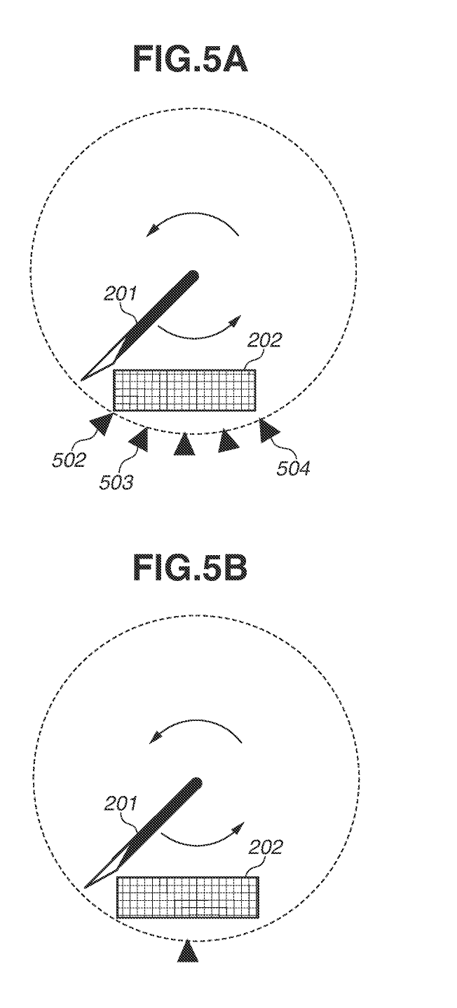

Examples of the rotation operation of the cutter 201 on the object-to-be-inspected 202 and the timing when the pattern detection signal is generated will now be described with reference to FIGS. 5A and 5B. FIGS. 5A and 5B each illustrate a state of the rotation operation of the cutter 201 in a top view on the inspection stage 200. For example, FIG. 5A illustrates a case where image data of a plurality of still images is obtained to observe a state of cutting the object-to-be-inspected 202 a plurality of times during one rotation of the cutter 201. When the cutter 201 is rotated, the object-to-be-inspected 202 is cut. At each timing when the cutter 201 passes through positions (pattern detection points) indicated by black triangles 502 and 503 and the like, the pattern detection unit 106 supplies the control unit 110 with the pattern detection signal. In the present exemplary embodiment, the intervals between the pattern detection points are equal, but instead may be unequal. In other words, the pattern detection signal may be generated at various intervals. The generation timing of the pattern detection signal is limited to the timing when the object-to-be-inspected 202 is cut, thereby preventing capturing of unnecessary still image data.

While the present exemplary embodiment illustrates an example in which the pattern detection signal is generated from the pattern detection unit 106 in the image capturing apparatus 102, the present exemplary embodiment is not limited to this example. A configuration in which a trigger signal is generated after an image is captured and a pattern is detected by the PC 101 may also be used.

FIG. 5B illustrates another example in which image data of one still image is acquired to observe a state of cutting the object-to-be-inspected 202 once during one rotation of the cutter 201.

Accordingly, intervals between the generation timing of a trigger signal in a first rotation and the generation timing of a trigger signal in a second rotation are equal.

The pattern detection signal is output after a predetermined pattern is detected by the pattern detection unit 106 according to the present exemplary embodiment, which causes an occurrence of a delay. On the other hand, the timing may be adjusted in consideration of a delay in the second and subsequent rotations based on the premise that an interval at which the pattern detection signal is generated is known. Specifically, the pattern detection signal may be generated in consideration of a delay amount corresponding to a frame rate.

Referring again to FIG. 4, in step S403, the control unit 110 counts the number of pattern detection signals received after the operation is started, and determines which one of the pattern detection signals is received in the previous step S402. As a result of determination, if it is determined that the first pattern detection signal is received (“FIRST SIGNAL” in step S403), the processing proceeds to step S404. If it is determined that the second or subsequent pattern detection signal is received (“SECOND OR SUBSEQUENT SIGNAL” in step S403), the processing proceeds to step S406. In step S403, information indicating whether the frame based on which the pattern detection signal is output corresponds to a low-exposure image or a high-exposure image is stored.

In step S404, the control unit 110 causes a frame counter unit to start counting the number of frames from the time when the first detection signal is input. The counted number is stored in the memory 109 or the like and is updated as needed. Then, the processing proceeds to step S405.

In step S405, the control unit 110 reads frame images from the memory 109 while acquiring image data from the image sensor 104 at a predetermined frame rate, and loads the frame images into the PC 101 through the control unit 110. Then, the processing returns to step S402 to wait for the input of the subsequent pattern detection signal.

In step S406, the control unit 110 detects a counted number of pattern detection signals to be received based on the counting result Fnum obtained by the frame counter unit, and resumes counting the number of frames. Then, the processing proceeds to step S407.

In step S407, the control unit 110 reads frame images from the memory 109 while acquiring image data from the image sensor 104 at a predetermined frame rate, and loads the frame images into the PC 101 through the control unit 110. Then, the processing proceeds to step S408.

In step S408, the control unit 110 estimates the number of frames from the frame in which a pattern is detected until the frame in which the subsequent pattern detection signal is output, based on the number of frames (Fnum) counted until the subsequent pattern is detected. Then, it is determined which one of a low-exposure image and a high-exposure image is output from the image sensor 104 at the estimated timing when the pattern detection signal is generated. Further, replacement of the low-exposure image and the high-exposure image to be acquired for image data acquired at a predetermined timing is performed using the determination result. If it is determined that the replacement is required (YES in step S408), the processing proceeds to step S409. If it is determined that the replacement is not required (NO in step S408), the processing proceeds to step S410 to wait for the input of the subsequent pattern detection signal.

As an example of the determination method in step S408, when a constant interval is set with the same desired image capturing position as illustrated in FIG. 5B, pattern detection signals are provided at constant frame intervals. By using this fact, the number of frames between the pattern detection signals is counted and the determination is made using information about whether the count value is an even number or an odd number, or information indicating whether the frame based on which the first pattern detection signal is output corresponds to a high-exposure image or a low-exposure image. Specifically, when the image based on which the pattern detection signal is output corresponds to a low-exposure image and when the number of frames is an even number, it is determined that the replacement of images is required, and then the processing proceeds to step S409. When the number of frames is an odd number, the processing proceeds to step S410. On the other hand, when the image based on which the pattern detection signal is output corresponds to a high-exposure image and when the number of frames is an odd number, it is determined that the replacement of images is required, and then the processing proceeds to step S409. When the number of frames is an even number, the processing proceeds to step S410.

As still another example, when a plurality of image capturing acquisition intervals is present as illustrated in FIG. 5A, a plurality of numbers of frames between the pattern detection signals is stored and periodicity is detected. Assume in FIG. 5A that the number of frames between a pattern detection point 502 and a pattern detection point 503 is represented by F1 and the number of frames between the pattern detection point 502 and a pattern detection point 504 is represented by F2. Output timings of four pattern detection signals are estimated using the frame number F1, and then an output timing of one pattern detection signal is estimated using the frame number F2.

By the control processing as described above, the estimation can be performed with high accuracy. The number and timing of the frame number F1 can also be set by the PC 101. However, the operation in the flowchart illustrated in FIG. 4 may be repeatedly estimated by machine learning using deep learning or the like.

In the example illustrated in FIG. 5A, the frame number F1 is extremely small, and thus the estimation is not always required. In such a case, the estimation may be performed using only the frame number F2 which is a relatively long time interval between the pattern detection point 502 and the pattern detection point 504. Specifically, the estimation is performed when the interval between the pattern detection signals is longer than a predetermined time, which leads to a reduction in calculation load. In addition, it is difficult to perform the rotation operation of the cutter 201 at a completely constant rate, and a variation occurs during the generation of the pattern detection signal. Accordingly, in order to increase the accuracy of F1 used for estimation, a value F1ave obtained as a result of statistical processing, such as averaging calculation, based on the result of F1 obtained after performing counting a plurality of times, may be used for estimating the timing of the subsequent pattern detection signal.

In step S409, the control unit 110 performs switching between the low-exposure image and the high-exposure image to be acquired at the subsequent VD timing. More specifically, when it is estimated that the low-exposure image is output from the image sensor 104 at the time when the subsequent detection signal estimated in step S408 is generated, the operation of switching the order of acquisition of the low-exposure image and the high-exposure image is carried out. This is because the image data of the combined HDR image is acquired after the high-exposure image is output. By switching the order of acquisition of image data, a time required for acquiring the image data of the HDR image from the time when the pattern detection signal is generated can be reduced.

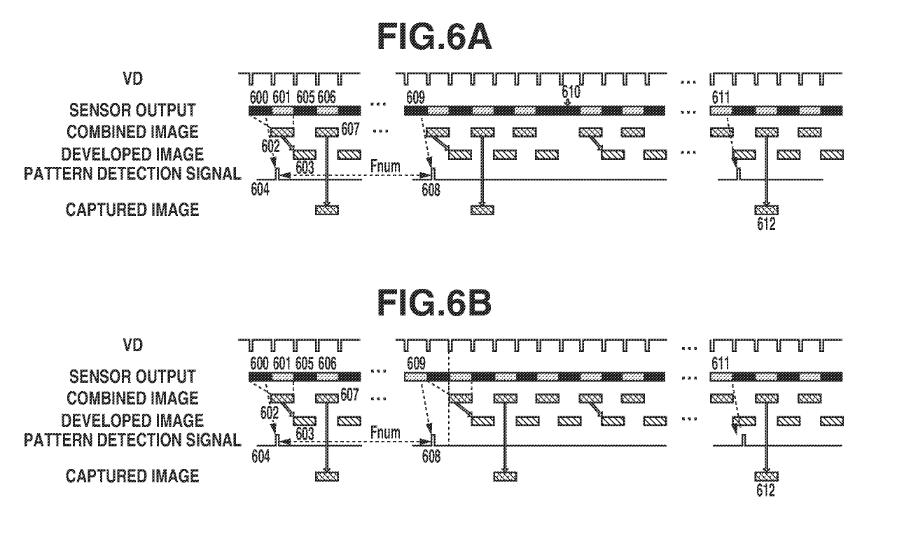

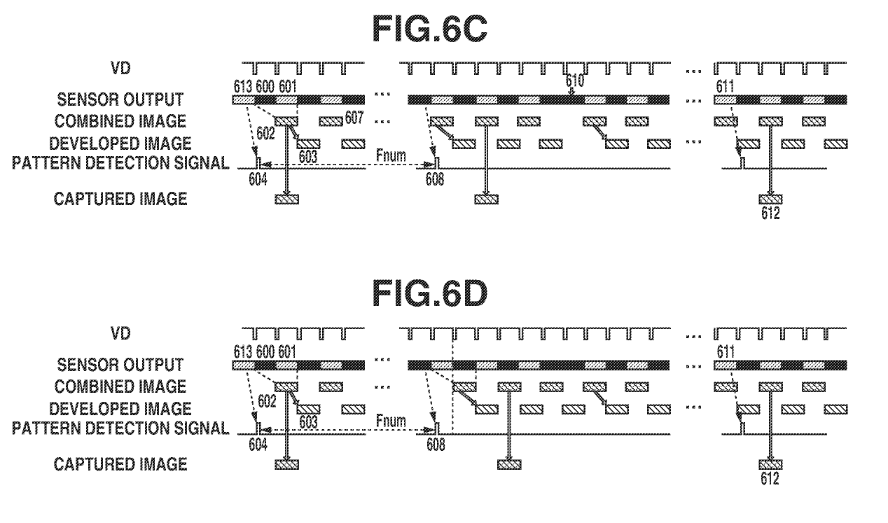

The operation in step S409 will now be described in detail with reference to FIGS. 6A to 6D. FIGS. 6A to 6D each illustrate the VD corresponding to the read-out cycle of the image sensor 104, the output timing of image data from the image sensor 104, the output timing of the HDR image obtained through combining processing by the combining unit 107, and the output timing of image data on which development processing is performed by the development processing unit 108. FIGS. 6A to 6D also illustrate output timings of pattern detection signals and images to be actually captured as timings for loading image data of still images into the PC 101.

FIGS. 6A and 6C each illustrate an operation in which the order of acquisition of the low-exposure image and the high-exposure image is switched in step S409. FIGS. 6B and 6D each illustrate an operation in which the order of acquisition of the low-exposure image and the high-exposure image is not switched in step S409. In both cases, the control unit 110 sets a parameter for acquiring the low-exposure image to the image sensor 104, starts reading in synchronization with the VD, and reads image data 600 from the low-exposure image. After that, the control unit 110 sets a parameter for acquiring the high-exposure image to the image sensor 104, starts reading in synchronization with the VD, and reads image data 601 from the high-exposure image. The combining unit 107 combines the low-exposure image 600 and the high-exposure image 601, thereby generating image data 602 of one HDR image. The development processing unit 108 performs development processing on HDR images that are sequentially acquired, and converts the HDR images into a moving image format, such as an MPEG format, thereby generating developed image data 603. The generated developed image data 603 is used to generate a continuous moving image on the display unit 111. Then, image data of the HDR image generated from the low-exposure image acquisition timing subsequent to the timing when a pattern detection signal 608 is input is output as a captured image.

FIG. 6A illustrates that a pattern detection signal 604 is output from the low-exposure image 600, and the high-exposure image 601 is set as a first frame, and then the number of frames is counted. The combined image 602 is an HDR combined image obtained by combining the low-exposure image 600 and the high-exposure image 601, and the frame image 603 that is developed by the development processing unit 108 is output to the display unit 111 or the like. Further, an image 607 obtained by combining a low-exposure image 605, which is obtained after the pattern detection signal 604 is output, and a high-exposure image 606 is recorded on the memory 109 as a still image, and is output to the PC 101 through the control unit 110. Further, the number of frames Fnum counted until the next pattern detection signal 608 is output is detected. The number of frames Fnum corresponds to the number of frames in a range from the high-exposure image 601 to a low-exposure image 609. When it is determined that the number of frames Fnum is an even number in step S408 illustrated in FIG. 4, the acquisition timings of the high-exposure image and the low-exposure image are switched. As a result of switching in FIG. 6A, a low-exposure image 610 is acquired at the acquisition timing of the high-exposure image.

Replacement of the high-exposure image and the low-exposure image may be performed at a location other than the timing illustrated in FIG. 6A. However, it is desirable to perform the replacement sufficiently earlier than the estimated timing of the subsequent pattern detection signal.

As illustrated in FIG. 6A, when the pattern detection signal is output based on the low-exposure image and the number of frames Fnum is an even number, the pattern detection signal is output at the acquisition timing of a low-exposure image 611. Then, the subsequent combined image obtained by combining the low-exposure image and the high-exposure image can be captured as a combined image 612. As a result, the combined image can be acquired with a small time lag (after two frames).

Next, FIG. 6B illustrates a case where the pattern detection signal 604 is output from the low-exposure image 600 and the number of frames Fnum counted from the high-exposure image 601 as the first frame is an odd number. In this case, there is no need to replace the frames. In other words, the combined image 612 can be acquired after two frames even after the subsequent pattern detection signal is output.

Next, FIG. 6C illustrates a case where the pattern detection signal 604 is output from a high-exposure image 613 and the number of frames Fnum counted from the low-exposure image 600 as the first frame is an odd number. In this case, it is determined that the acquisition timings of the low-exposure image and the high-exposure image are to be switched in step S408 illustrated in FIG. 4. Referring to FIG. 6C, as a result of switching, the high-exposure image 610 is acquired at the acquisition timing of the low-exposure image. The combined image can be acquired with a small time lag (after two frames) by performing the switching.

Next, FIG. 6D illustrates a case where the pattern detection signal 604 is output from the high-exposure image 613 and the number of frames Fnum counted from the low-exposure image 600 as the first frame is an even number. In this case, there is no need to replace the frames. In other words, the combined image 612 can be acquired after two frames even after the subsequent pattern detection signal is output.

As described above, the operation of the image sensor 104 at the generation timing of the subsequent pattern detection signal can be estimated based on the interval at which the pattern detection signal is generated, and the order of acquisition of image data can be controlled based on whether the image data obtained at the generation timing of the subsequent pattern detection signal corresponds to a high-exposure image or a low-exposure image. Consequently, a time lag between generation of the pattern detection signal and capturing of an image can be reduced, and image capturing can be performed at a more stable timing.

The image capturing apparatus 102 continuously captures images at a predetermined frame rate. However, when control processing for an external apparatus to be carried out asynchronously with image capturing is repeated at a predetermined cycle, periodic waviness occurs. The waviness is, for example, a displacement in timing, a displacement in angle of view, or a displacement in the position of the cutter 201. The waviness causes noise that inhibits an appropriate inspection of the object-to-be-inspected 202. By applying the present disclosure to such a case, the waviness caused by a displacement in the operation (e.g., the cutter 201) to be asynchronously performed with the image capturing apparatus 102 can be reduced.

To detect an interval at which a first trigger signal is generated, the cutter 201 may be caused to perform a preliminary rotation without cutting the object-to-be-inspected 202. Further, a preliminary trigger point may be provided immediately before a location where the object-to-be-inspected 202 is cut, and control processing may be performed so that a first trigger point can be estimated.

Further, the PC 101 monitors the rotation speed and corrects the trigger position, as needed, to set a desired trigger position where the object-to-be-inspected 202 is actually cut. Alternatively, the speed may be output to the control unit 110 in the image capturing apparatus 102, and control processing may be performed so that the estimated position of the pattern detection position can be corrected in accordance with a variation in the speed of the cutter 201.

Further, to adjust the timing of the subsequent pattern detection signal and the image capturing timing, it is possible not only to replace the order of acquisition of the low-exposure image and the high-exposure image, but also to adjust the timing by adjusting an acquisition interval (frame rate).

When a plurality of pattern detection positions is set in one rotation as illustrate in FIG. 5A, the estimated frame number F1 is set. If no pattern detection signal is input after a lapse of the estimated frame number F1, the time measurement may be interrupted and control processing may be performed so that the time is measured again from the subsequent pattern detection point.

In a case where a plurality of pattern detection frame intervals F1 and F2 is set, if no pattern detection signal is input after a lapse of F1, which indicates a smaller number of counted frames, the timing when the subsequent pattern detection signal is generated may be determined to correspond to F2, which indicates a larger number of counted frames, and control processing may be performed so that the estimation is carried out again. The present exemplary embodiment is not limited to this example, and the estimation may be performed a plurality of number of times so as to improve the estimation accuracy. The exemplary embodiment described above is carried out by counting the number of frames, but instead may be carried out by measuring the time.

As described above, the number of frames is counted at image capturing intervals, and the generation timing of the subsequent pattern detection signal is estimated and which one of the low-exposure image and the high-exposure image is read at the timing is also estimated. Thus, a time required from the generation of the pattern detection signal to the actual image capturing timing can be reduced. The estimation of the generation timing of the subsequent pattern detection signal reduces a load on a user to set the timing and makes it possible to increase the versatility of the system. For example, there is no need to adjust the rotation operation of the cutter 201 and the image capturing timing of the image capturing apparatus 102, and the rotation speed of the cutter 201 and exposure conditions for the image capturing apparatus 102 can be arbitrarily set.

A second exemplary embodiment of the present disclosure will now be described. In the first exemplary embodiment, the operation to be performed in the HDR drive mode in which a plurality of images is combined to increase the dynamic range has been described. Since there is a need to acquire a plurality of images to acquire one HDR image in the HDR drive mode, the image capture rate decreases depending on the number of images to be combined. Specifically, if the pattern detection signal is generated immediately before the acquisition of image data is started, a time lag in the acquisition of image data is minimum. If the pattern detection signal is generated immediately after the acquisition of image data is started, a delay corresponding to the frame rate occurs.

This phenomenon is not limited to the HDR drive mode. For example, in the case of capturing an image of a low-brightness subject, a problem similar to that described above is also caused in a so-called slow shutter drive mode in which the frame rate is reduced to increase an exposure time. Further, in the slow shutter drive mode, the frame rate of the output from the image sensor 104 decreases, and the resolution of the image pattern detection signal also decreases by an amount corresponding to a decrease in the frame rate, which makes it difficult to perform pattern detection at an optimum image capturing position. In the present exemplary embodiment, slow shutter driving is suitable when image capturing is performed at a frame rate lower than 30 fps, for example, at a frame rate of about 8 to 10 fps.

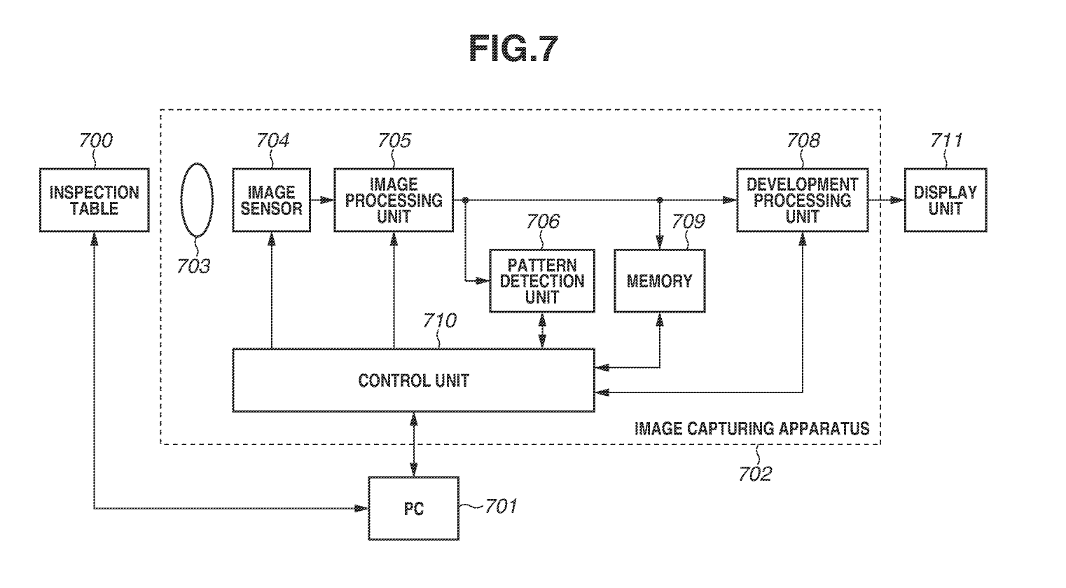

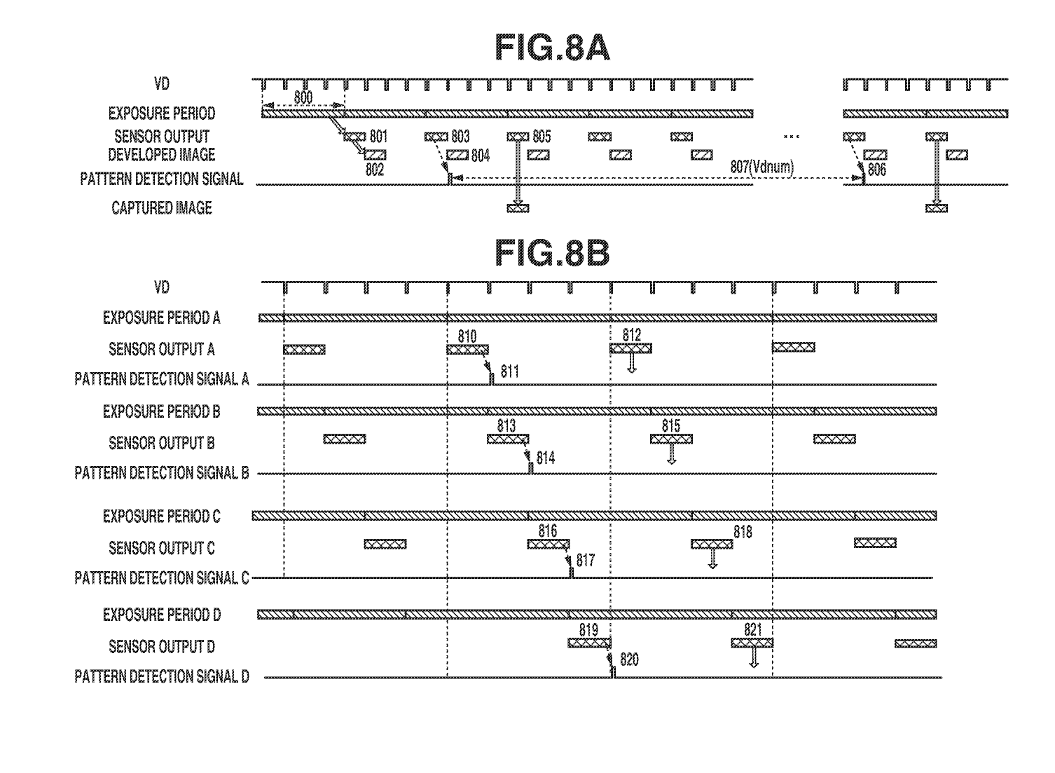

An application for control processing in the slow shutter drive mode according to the second exemplary embodiment will be described below with reference to FIG. 7 and FIGS. 8A and 8B. FIG. 7 is a detailed block diagram illustrating an image capturing system according to the second exemplary embodiment. The components of the image capturing system illustrated in FIG. 7 respectively correspond to the components of the image capturing system illustrated in FIG. 1 according to the first exemplary embodiment. The configuration illustrated in FIG. 7 differs from the configuration illustrated in FIG. 1 in that there is no block corresponding to the combining unit 107 and a memory 709 is configured to hold image data from an image processing unit 705.

The second exemplary embodiment illustrates a slow shutter mode in which exposure is performed by an image sensor in a period corresponding to four VDs and image data is read from the image sensor once every four VDs. In the present exemplary embodiment, image data is read from the image sensor with one of the four output VDs as a trigger, but instead control processing may be performed to output the VD itself once every 4 intervals of the vertical synchronization signal.

FIGS. 8A and 8B are timing diagrams each illustrating reading of image data, generation of the pattern detection signal, and timings of development data and a captured image according to the second exemplary embodiment. Referring to FIG. 8A, an image sensor 704 outputs a sensor output 801 to the image processing unit 705 after exposure in the period corresponding to four VDs (800). Further, the sensor output 801 is input to a development processing unit 708 and is output to the display unit 711 or the like as a developed image 802. Each sensor output is also input to a pattern detection unit 706. Like in the first exemplary embodiment, when a predetermined pattern is detected in an image, the pattern detection signal is output to a control unit 710.

FIG. 8A illustrates a case where the predetermined pattern is detected in a sensor output 803. When the predetermined pattern is detected by the pattern detection unit 706 and a pattern detection signal 804 is output, image data 805 of the sensor output obtained after the subsequent exposure operation is loaded into a PC 701 through the memory 709.

As described above, in the second exemplary embodiment, image data is read by the sensor once every 4 VDs, so that the pattern detection signal is also output based on the interval corresponding to four VDs, which leads to a decrease in the output resolution of the pattern detection signal.

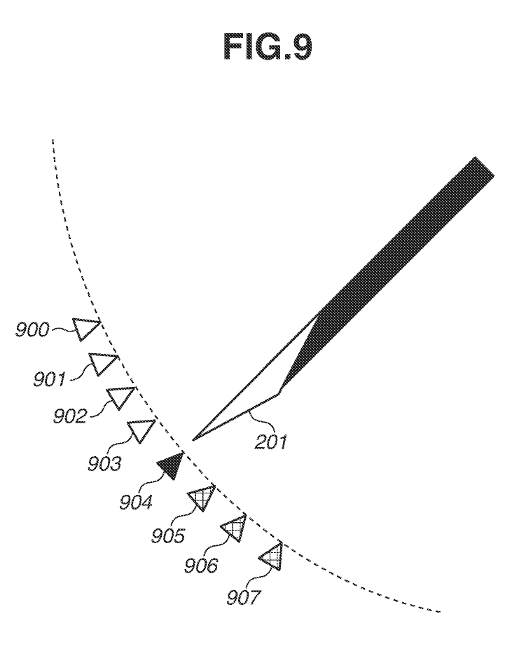

FIG. 9 illustrates the cutter 201 and the positional relationship between the image capturing timing and the pattern detection timing. Each triangular shape indicates the VD generation timing. In particular, a black triangle 904 indicates the image capturing timing and also indicates a position where an image is to be read after the exposure in the period corresponding to four VDs. Triangles 900 to 903 each illustrate a cutter position where the pattern detection signal is output. An interval between 900 and 901, an interval between 901 and 902, and an interval between 903 and 904 each correspond to a temporal period of one VD. Shaded triangles 905 to 907 each illustrate a timing for actually capturing a still image. An interval between 905 and 906, an interval between 906 and 907, and an interval between 907 and 908 corresponds to a temporal period corresponding to one VD.

In the case of acquiring a still image of image data from the image sensor 704 at the timing indicated by 904, when the pattern detection signal is output at the position 900 before the interval corresponding to four VDs, a desired still image can be obtained from the position 904.

This state is indicated by the timing diagram illustrating the VD, an exposure period A, a sensor output A, and a pattern detection signal A in FIG. 8B. When a pattern detection signal 811 (corresponding to the position 900 illustrated in FIG. 9) is output, a sensor output 812 (corresponding to the position 904 illustrated in FIG. 9) is loaded into the PC 701 through the memory 709.

However, as illustrated in FIG. 8B, assuming that the pattern detection signal is output based on sensor outputs B to D, a delay occurs at the assumed timing 904. As for the image pattern detection according to the second exemplary embodiment, the period of displacement, as a number of VD's, is detected by detecting a displacement amount with respect to the position (position 900 illustrated in FIG. 9) where the pattern detection is assumed to be carried out.

First, as illustrated in FIG. 8A, simultaneously with the output of the first pattern detection signal 804 to the control unit 710, a displacement amount (VDs1) of the image pattern is detected to thereby detect the displacement amount, i.e., the number of VDs, with respect to the position 900, which is an appropriate image pattern position, as illustrated FIG. 9. Further, the detected displacement amount is output to the control unit 710. The position where there is no displacement amount corresponds to the position 900 illustrated in FIG. 9. The position where there is a displacement of one VD corresponds to the position 901. The position where there is a displacement of two VDs corresponds to the position 902. The position where there is a displacement of three VDs corresponds to the position 903. Then, the control unit 710, after receiving the pattern detection signal 804 from the pattern detection unit 706, captures the image data 805 as a still image. Then, the number of VDs (VDnum), which corresponds to a period 807 for outputting a subsequent pattern detection signal 806, is counted. Further, the pattern detection unit 706 detects a displacement amount (VDs2) of the image pattern again upon output of the second pattern detection signal.

Since the pattern detection signal is output every four VDs, VDnum is a multiple of “4”. When the first pattern detection signal 804 is output, the number of VDs up to the position (900 illustrated in FIG. 9) where the subsequent pattern detection signal is to be output is estimated based on image pattern displacement amounts VDs1 and VDnum and an image pattern displacement amount VDs2 obtained when the second pattern detection signal is output. Specifically, the number of VDs between the image pattern detection signals is calculated in consideration of the displacement amount of the image pattern, and the calculation result is used as the number of VDs up to the position (900 illustrated in FIG. 9) where the subsequent pattern detection signal is to be output. The number of VDs between the image pattern detection signals can be obtained by an expression “VDnum−VDs1+VDs2”.

Further, control processing for shifting the exposure start timing in units of VD is based on the relationship between a remainder left after the number of VDs between the image pattern detection signals (VDnum) is divided by the frame rate (“4” in the present exemplary embodiment) and the image pattern displacement amount VDs2 obtained when the second pattern detection signal is output. In the present exemplary embodiment, the frame rate is “4” and the image pattern detection signal is output every four VDs. Accordingly, since VDnum is a multiple of “4”, the remainder is obtained by VDs2−VDs1 and 0, 1, 2, and 3 can be taken as values.

When VDs2−VDs1=0, the exposure start timing is controlled so that the subsequent image pattern detection signal is output after a lapse of VDnum after the second pattern detection signal is output, thereby making it possible to output the image pattern detection signal at a desired timing. In this case, if the displacement amount of VD in the second pattern detection signal is “0”, i.e., when VDs2=0, there is no need to shift the exposure start timing.

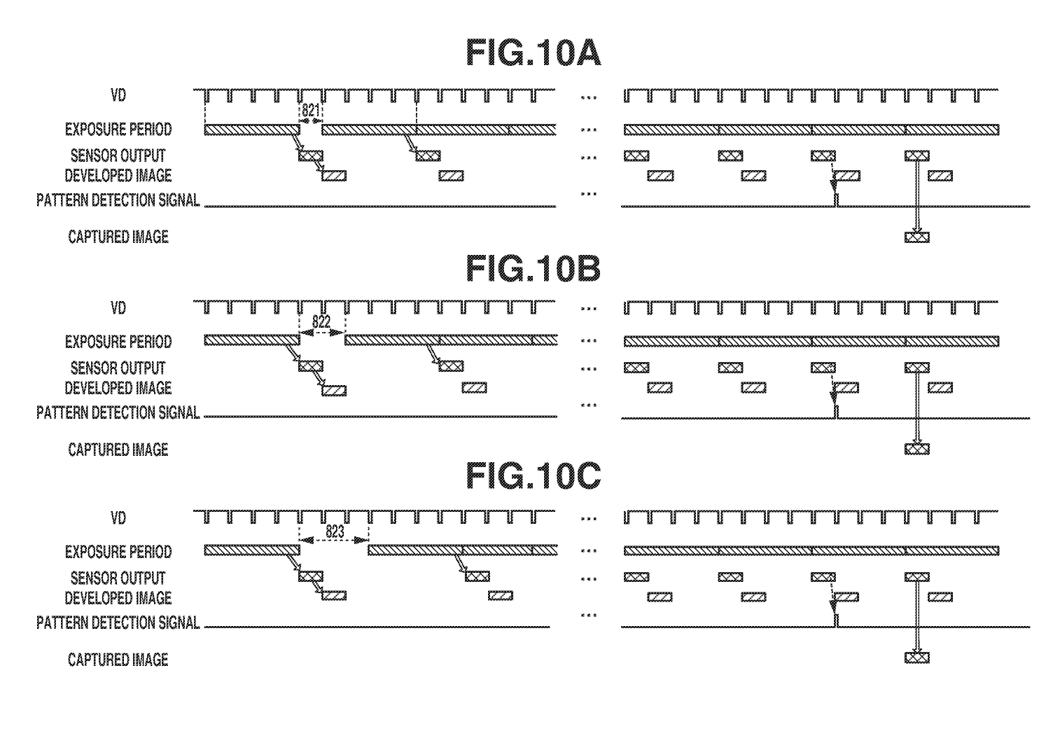

When the displacement amount of VD in the second pattern detection signal is “1” (VDs2=1), the position 901 illustrated in FIG. 9 is obtained after a lapse of VDnum, so that there arises a need to shift the exposure start timing. Processing for controlling the exposure start timing will be described with reference to timing diagrams of FIGS. 10A, 10B, and 10C. As described above, when VDs2=1, as indicated by 823 in FIG. 10C, the subsequent exposure start timing is shifted by a period corresponding to three VDs, and the image pattern detection signal obtained after a lapse of VDnum−4 corresponds to the position 900 illustrated in FIG. 9, which is a desired pattern detection position.

Further, when the displacement amount of VD in the second pattern detection signal is “2” (VDs2=2), the position 902 illustrated in FIG. 9 is obtained after a lapse of VDnum. Accordingly, the exposure start timing is controlled so as to be shifted by a period corresponding to two VDs as indicated by 822 in FIG. 10B. Then, the image pattern detection signal obtained after a lapse of VDnum−4 is located at the position 900 illustrated in FIG. 9 which is a desired pattern detection position.

Similarly, when the displacement amount of VD in the second pattern detection signal is “3” (VDs2=3), control processing for shifting the timing by a period corresponding to one VD as indicated by 821 in FIG. 10A is performed, so that the position 900 illustrated in FIG. 9 is obtained.

Next, the case of VDs2−VDs1=1 will be described. When VDs2−VDs1=1, the exposure start timing is controlled to output the subsequent image pattern detection signal after a lapse of VDnum+1 after the second pattern detection signal is output, thereby making it possible to output the image pattern detection signal at a desired timing. Therefore, when the displacement amount of VD in the second pattern detection signal is “3” (VDs2=3 and 820 illustrated in FIG. 8B), the desired position 900 illustrated in FIG. 9 is obtained after a lapse of VDnum+1, which eliminates the need to shift the timing of starting the exposure period.

Next, when the displacement amount of VD in the second pattern detection signal is “2” (VDs2=2 and 817 illustrated in FIG. 8B), the position 903 illustrated in FIG. 9 is obtained after a lapse of VDnum+1, so that there arises a need to shift the exposure start timing. Specifically, the exposure start timing is shifted by a period corresponding to one VD as indicated by 821 in FIG. 10A, and when (VDnum+1)−4 holds, i.e., after a lapse of VDnum−3, the second pattern detection signal is located at the desired position 900.

When the displacement amount of VD in the second pattern detection signal is “1” (VDs2=1 and 814 illustrated in FIG. 8B), the position 902 illustrated in FIG. 9 is obtained after a lapse of VDnum+1, so that there arises a need to shift the exposure start timing. Specifically, the exposure start timing is shifted by a period corresponding to two VDs as indicated by 822 in FIG. 10B, and then when (VDnum+1)−4 holds, i.e., after a lapse of VDnum−3, the second pattern detection signal is located at the desired position 900.

Further, when the displacement amount of VD in the second pattern detection signal is “0” (VDs2=0 and 811 illustrated in FIG. 8B), the position 901 illustrated in FIG. 9 is obtained after a lapse of VDnum+1, so that there arises a need to shift the exposure start timing. Specifically, the exposure start timing is shifted by a period corresponding to three VDs as indicated by 823 in FIG. 10C, and when (VDnum+1)−4 holds, i.e., after a lapse of VDnum−3, the second pattern detection signal is located at the desired position 900.

Next, the case of VDs2−VDs1=2 will be described. When VDs2−VDs1=2 holds, the exposure start timing is controlled so that the subsequent image pattern detection signal is output after a lapse of VDnum+2 after the second pattern detection signal is output, thereby making it possible to output the image pattern detection signal at a desired timing. Therefore, when the displacement amount of VD in the second pattern detection signal is “2” (VDs2=2 and 817 illustrated in FIG. 8B), the desired position 900 illustrated in FIG. 9 is obtained after a lapse of VDnum+2, so that there is no need to shift the exposure period start timing.

Next, when the displacement amount of VD in the second pattern detection signal is “1” (VDs2=1 and 814 illustrated in FIG. 8B), the pattern detection signal obtained after a lapse of VDnum+2 is located at the position 903 illustrated in FIG. 9, so that there arises a need to shift the exposure start timing. Specifically, the exposure start timing is shifted by a period corresponding to one VD as indicated by 821 in FIG. 10A, and then the second pattern detection signal obtained when (VDnum+2)−4 holds, i.e., after a lapse of VDnum−2, is located at the desired position 900.

Further, when the displacement amount of VD in the second pattern detection signal is “0” (VDs2=0 and 811 illustrated in FIG. 8B), the pattern detection signal obtained after a lapse of VDnum+2 is located at the position 902 illustrated in FIG. 9, so that there arises a need to shift the exposure start timing. Specifically, the exposure start timing is shifted by a period corresponding to two VDs as indicated by 822 in FIG. 10B, and then the second pattern detection signal obtained when (VDnum+2)−4 holds, i.e., after a lapse of VDnum−2, is located at the desired position 900.

Further, when the displacement amount of VD in the second pattern detection signal is “3” (VDs2=3 and 820 illustrated in FIG. 8B), the position 901 illustrated in FIG. 9 is obtained after a lapse of VDnum+2, so that there arises a need to shift the exposure start timing. Specifically, the exposure start timing is shifted by a period corresponding to three VDs as indicated by 823 in FIG. 10C, and then when (VDnum+2)−4 holds, i.e., after a lapse of VDnum−2, the second pattern detection signal is located at the desired position 900.

Next, the case of VDs2−VDs1=3 will be described. When VDs2−VDs1=3 holds, the exposure start timing is controlled so that the subsequent image pattern detection signal is output after a lapse of VDnum+3 after the second pattern detection signal is output, thereby making it possible to output the time pattern detection signal at a desired timing. Therefore, when the displacement amount of VD in the second pattern detection signal is “1” (VDs2=1 and 814 illustrated in FIG. 8B), the desired position 900 illustrated in FIG. 9 is obtained after a lapse of VDnum+3, so that there is no need to shift the exposure period start timing.

Next, when the displacement amount of VD in the second pattern detection signal is “0” (VDs2=0 and 811 illustrated in FIG. 8B), the pattern detection signal obtained after a lapse of VDnum+3 is located at the position 903 illustrated in FIG. 9, so that there arises a need to shift the exposure start timing. Specifically, the exposure start timing is shifted by a period corresponding to one VD as indicated by 821 in FIG. 10A, and then the second pattern detection signal obtained when (VDnum+3)−4 holds, i.e., after a lapse of VDnum−1 indicates the desired position 900.

Further, when the displacement amount of VD in the second pattern detection signal is “3” (VDs2=3 and 820 illustrated in FIG. 8B), the pattern detection signal obtained after a lapse of VDnum+3 is located at the position 902 illustrated in FIG. 9, so that there arises a need to shift the exposure start timing. Specifically, the exposure start timing is shifted by a period corresponding to two VDs as indicated by 822 in FIG. 10B, and then the second pattern detection signal obtained when (VDnum+3)−4 holds, i.e., after a lapse of VDnum−1, is located at the desired position 900.

Further, when the displacement amount of VD in the second pattern detection signal is “2” (VDs2=2 and 817 illustrated in FIG. 8B), the pattern detection signal obtained after a lapse of VDnum+3 is located at the position 901 illustrated in FIG. 9, so that there arises a need to shift the exposure start timing. Specifically, the exposure start timing is shifted by a period corresponding to three VDs as indicated by 823 in FIG. 10C, and then the second pattern detection signal obtained when (VDnum+3)−4 holds, i.e., after a lapse of VDnum−1, is located at the desired position 900.

As described above, the position of the subsequent pattern detection signal is estimated based on the number of VDs between the pattern detection signals and the displacement amount of a desired pattern detection position when the pattern detection signal is output, and the exposure start timing is controlled, thereby obtaining a desired image pattern detection signal. Further, the rotation speed of the inspection table 700 may be detected by the PC 701 and control processing may be performed to correct the estimated position of the pattern detection signal.

In the present exemplary embodiment, the position for pattern detection is estimated by counting the number of VD intervals, but instead an actual time may be measured and control processing may be performed in accordance with the measured time, instead of controlling the exposure start timing in units of VD. Further, all or a part of the operation of the image capturing apparatus may be interrupted, as needed, during a time other than the image capturing operation, to thereby save power.

As described above, also in the slow shutter control for performing exposure in a plurality of frame periods, the output timing of the subsequent pattern detection signal is estimated based on the time between the pattern detection signals and the displacement amount from the optimum pattern detection position, and the exposure start timing is controlled, thereby making it possible to acquire a still image at a desired timing without any adverse effect on a moving image in the vicinity of the pattern detection timing.

As described above, it is possible to provide an image capturing apparatus capable of reducing a delay by estimating a timing for actually capturing an image based on a pattern detection signal.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-086496, filed Apr. 27, 2018, which is hereby incorporated by reference herein in its entirety.

What is claimed is:

1. An image capturing apparatus that repeatedly captures an image of an object at a first timing, the image capturing apparatus comprising:
an image sensor configured to acquire image data of the object, and
a controller having a processor which executes instructions stored in a memory, the controller being configured to function as:
a control unit configured to control driving of the image sensor; and
an acquisition unit configured to acquire a second timing generated by detecting an image pattern of the object in the image data,
wherein the control unit controls driving of the image sensor based on an interval between the first timings and an interval between the second timings.

2. The image capturing apparatus according to claim 1, wherein the control unit includes an estimation unit configured to estimate the second timing based on a plurality of intervals between the second timings.

3. The image capturing apparatus according to claim 2, wherein the estimation unit estimates the second timing based on a position of the object in the image data during the image pattern detection and the plurality of intervals between the second timings.

4. The image capturing apparatus according claim 1, wherein the control unit generates a moving image based on image data acquired at the first timing, and generates a still image based on image data acquired at the second timing.

5. The image capturing apparatus according claim 1, further comprising a combining unit configured to combine a plurality of pieces of image data,
wherein the control unit periodically sets different types of exposures to the image sensor, and
wherein the combining unit generates image data with an increased dynamic range by combining a plurality of pieces of image data acquired based on the different types of exposures.

6. The image capturing apparatus according to claim 5, wherein the different types of exposures include one of a high exposure and a low exposure, the high exposure and the low exposure being set based on a predetermined exposure.

7. The image capturing apparatus according to claim 5, wherein the control unit switches an exposure to be set to the image sensor based on the interval between the first timings and the interval between the second timings.

8. The image capturing apparatus according to claim 1,
wherein the first timing is a vertical synchronization signal, and
wherein the control unit controls driving of the image sensor to acquire image data in a plurality of vertical synchronization signals.

9. The image capturing apparatus according to claim 8, wherein the control unit switches a timing for starting an exposure set to the image sensor based on the interval between the first timings and the interval between the second timings.

10. The image capturing apparatus according to claim 1, wherein the interval between the second timings includes a plurality of time intervals.

11. A control method for an image capturing apparatus that comprises an image sensor configured to acquire image data of an object and repeatedly captures an image at a first timing, the control method comprising:
controlling driving of the image sensor; and
acquiring a second timing generated by detecting an image pattern of the object in the image data,
wherein driving of the image sensor is controlled based on an interval between the first timings and an interval of the second timings.
